(19) United States
(12) Patent Application Publication
(10) Pub. No.: US 2011/0124454 A1
(43) Pub. Date: May 26, 2011

(54) Power Transmission Mechanism for an Electric Bicycle

(76) Inventor: Kang Young Song, Seoul (KR)

(21) Appl. No.: 13/055,592

(22) PCT Filed: Apr. 9, 2010
(86) PCT No.: PCT/KR10/02207

§ 371 Date: Jan. 24, 2011

(30) Foreign Application Priority Data
Apr. 13, 2009 (KR) 10-2009-0031691
May 11, 2009 (KR) 10-2009-0040549

(51) Int. Cl. B62M 6/55

(52) U.S. Cl. 474/158

(57) ABSTRACT

A power transmission mechanism 5000 for an electric bicycle has a driving motor 990 mounted on the bicycle, and an outer shaft 580 with a hollow interior through which a crankshaft 590 of the bicycle penetrates. The outer shaft 580 is coupled to a driving sprocket 50 of the bicycle via an outer shaft combiner 18. The driving transmission mechanism 5000 of the electric bicycle has a driving motor connection one-way clutch 300 and a pedal connection one-way clutch 200.

### BACKGROUND OF THE INVENTION

The present invention relates to a power transmission mechanism for an electric bicycle and, more particularly to the power transmission mechanism for an electric bicycle which enhances the electric bicycle to run by motor power or by pressing power onto a pedal, respectively, or by resultant power of them. The present invention minimizes the power transmission loss to transmit the power efficiently and makes it possible to use selectively the motor power and the pressing power onto the pedal so that the rider can run the electric bicycle the most conveniently and the most comfortably.

Generally, an electric bicycle uses a hub motor to drive the rear wheel. In the electric bicycle using the hub motor, the friction between the driving part of the motor and the hub is high and the power transmission efficiency falls down. Also, pressing the pedal is hard unlike a general bicycle because of the high friction and it is hard to run only by the pressing power onto the pedal, the motor power being turned off. Accordingly, when a battery is exhausted or the rider wants to run the electric bicycle by his or her press onto the pedal, the running is not easy.

There is another way to run the electric bicycle. This way directly connects the motor power to the crank shaft and enhances the efficiency. For example, Korean Patent No. 0332831 shows this way of connecting the motor power to the crank shaft directly. In this case, three one-way clutches are used and the motor power and the pressing power onto the pedal are transmitted to the crank shaft independently.

In connection with power transmission mechanism, it is desirable to reduce the number of parts and make the structure simpler so that the installation, repair and the replacement become easy.

Meanwhile, it is also desirable to change the general bicycle into the electric bicycle by the installation of the power transmission mechanism thereon. In summary, it is desirable for the electric bicycle to transmit the motor power to the crank shaft directly and run selectively by the motor power and by the pressing power on to the pedal without interference between them with the minimized number of parts. At this time, it is further desirable if the general bicycle can be changed into the electric bicycle by the simple installation of the power transmission mechanism. The present invention satisfies these demands.

Meanwhile, it is desirable not to install as many power transmission parts as possible on the driving sprocket side. For example, it is desirable to install the motor on the opposite side of the driving sprocket side with center of the crank shaft housing. If the motor is installed on the driving sprocket side, chain for transmitting the power from the motor may interfere with the driving sprocket mechanism and it is hard to install the motor and a transmission as well. The present invention also satisfies this demand.

### SUMMARY OF THE INVENTION

The first purpose of the present invention is to provide a power transmission mechanism for an electric bicycle which selectively transmits motor power or pressing power onto pedal to the crank without interference between them to run the electric bicycle and changes a general bicycle into the electric bicycle by its simple installation thereon.

The second purpose of the present invention is to provide a power transmission mechanism for an electric bicycle the parts of which are not massed on the driving sprocket side and divided onto the both sides with center of the crank shaft housing so that its installation on the bicycle becomes easy and installation of a transmission for shifting gear ratio becomes easy too.

The present invention provides a power transmission mechanism for an electrical bicycle comprising: a driving motor mounted on a bicycle; a driving motor connection one-way clutch an outer wheel of which is connected with the driving motor and an inner wheel of which is connected with a driving sprocket of the bicycle to transmit the revolution power of the inner wheel to the driving sprocket; wherein the outer wheel and the inner wheel are locked together as the outer wheel revolves in the positive direction and the lock is released as the inner wheel revolves in the positive direction; a pedal connection one-way clutch an inner wheel of which is connected with a crank shaft of the bicycle and an outer wheel of which is connected with the driving sprocket of the bicycle to transmit the revolution power of the outer wheel to the driving sprocket; wherein the outer wheel and the inner wheel are locked together as the inner wheel revolves in the positive direction and the lock is released as the outer wheel revolves in the positive direction.

According to the present invention, it is preferable that the crank shaft is in noncontact with the driving motor connection one-way clutch.

According to the present invention, it is preferable that the driving motor connection one-way clutch and the pedal connection one-way clutch are arranged at left and right sides of the driving shaft, respectively.

According to the present invention, it is preferable that a motor side combiner coupled with the inner wheel of the driving motor connection one-way clutch is coupled with the left side of the driving sprocket so that the driving motor connection one-way clutch is connected with the driving sprocket, and a pedal side combiner coupled with the outer wheel of the pedal connection one-way clutch is coupled with the right side of the driving sprocket so that the pedal connection one-way clutch is connected with the driving sprocket.

According to the present invention, it is preferable that a motor side combiner coupled with the inner wheel of the driving motor connection one-way clutch is coupled with the left side of the driving sprocket so that the driving motor connection one-way clutch is connected with the driving sprocket, and extensions for combination formed on the outer wheel of the pedal connection one-way clutch is coupled with the right side of the driving sprocket so that the pedal connection one-way clutch is connected with the driving sprocket.

According to the present invention, it is preferable that a sprocket formed on the outer wheel of the driving motor connection one-way clutch is connected with the driving motor through a chain, a through-hole along the inner surface of which a thread part is formed is provided in the inner wheel of the driving motor connection one-way clutch, the motor side combiner has a protrusion on the outer surface of which a thread part is formed corresponding to the thread part on the inner surface of the through-hole in the inner wheel of the driving motor connection one-way clutch, a through-hole is provided in the protrusion, and the thread part on the through-hole of the inner wheel of the driving motor connection one-way clutch is coupled with the corresponding thread part on the protrusion of the motor side combiner so that the driving motor connection one-way clutch is connected with the driving sprocket.

According to the present invention, it is preferable that a thread part along the outer circumferential surface of the outer wheel is provided i the pedal connection one-way clutch, the pedal side combiner has a through-hole along the inner surface of which a thread part is formed corresponding to the thread part of the outer wheel of the pedal connection one-way clutch, the thread part on the outer wheel of the pedal connection one-way clutch is coupled with the corresponding thread part on the thread-hole of the pedal side combiner and the pedal connection one-way clutch is connected with the driving sprocket.

According to the present invention, it is preferable that a sprocket formed on the outer wheel of the driving motor connection one-way clutch is connected with the driving motor through a chain, a through-hole along the inner surface of which a thread part is formed is provided in the inner wheel of the driving motor connection one-way clutch, the motor side combiner has a protrusion on the outer surface of which a thread part is formed corresponding to the thread part on the inner surface of the through-hole in the inner wheel of the driving motor connection one-way clutch, a through-hole is provided in the protrusion, and the thread part on the through-hole of the inner wheel of the driving motor connection one-way clutch is coupled with the corresponding thread part on the protrusion of the motor side combiner so that the driving motor connection one-way clutch is connected with the driving sprocket.

According to the present invention, it is preferable that the outer wheel of the pedal connection one-way clutch has extensions for combination along their radial direction and the pedal connection one-way clutch is connected with the driving sprocket thereby, a mass part is provided on the crank shaft along which a thread part is formed corresponding to the thread part on the through-hole of the inner wheel of the pedal connection one-way clutch, and the threads are combined so that the inner wheel of the pedal connection one-way clutch is coupled with the crank shaft.

According to the present invention, it is preferable that the diameter of the through-hole of the motor side combiner is larger than the diameter of the crank shaft so that the crank shaft goes through the empty space of the through-hole of the motor side combiner and the crank shaft is in noncontact with the driving motor connection one-way clutch.

The present invention also provides a power transmission mechanism for an electrical bicycle comprising: a driving motor mounted on a bicycle; an outer shaft which is hollow, through which a crank shaft of the bicycle passes and which is connected with a driving sprocket of the bicycle; a driving motor connection one-way clutch an inner wheel of which is mounted on the outer shaft and an outer wheel of which is connected with the driving motor to receive power therefrom; wherein the outer wheel and the inner wheel are locked together as the outer wheel revolves in the positive direction and the lock is released as the inner wheel revolves in the positive direction; a pedal connection one-way clutch an inner wheel of which is mounted on the crank shaft of the bicycle and an outer wheel of which is connected with the driving sprocket of the bicycle; wherein the outer wheel and the inner wheel are locked together as the inner wheel revolves in the positive direction and the lock is released as the outer wheel revolves in the positive direction.

According to the present invention, it is preferable that the outer shaft is arranged to be through a crank shaft housing of the bicycle and the driving motor connection one-way clutch is arranged at the opposite side of the driving sprocket of the bicycle with center of the crank shaft housing.

According to the present invention, it is preferable that the crank shaft passes through the outer shaft on which the driving motor connection one-way clutch is mounted and the crank shaft and the driving motor connection one-way clutch are in noncontact with each other.

According to the present invention, it is preferable that an outer surface combiner mounted on the outer shaft is coupled with the driving sprocket of the bicycle so that the outer shaft is coupled with the driving sprocket of the bicycle.

According to the present invention, it is preferable that a pedal side combiner mounted on the outer wheel of the pedal connection one-way clutch is coupled with the driving sprocket of the bicycle so that the pedal connection one-way clutch is coupled with the driving sprocket of the bicycle.

According to the present invention, it is preferable that the pedal connection one-way clutch is coupled with the driving sprocket at its external side.

According to the present invention, it is preferable that the driving motor connection one-way clutch and the outer shaft combiner are mounted on protruded portion of the outer shaft from the crank shaft housing at its both ends, respectively.

According to the present invention, it is preferable that the pedal connection one-way clutch is mounted on the protruded portion of the crank shaft from the outer shaft.

According to the present invention, it is preferable that a bearing is provided between the crank housing and the outer shaft.

According to the present invention, only two one-way clutches are used to transmit the motor power and the pressing power onto the pedal to the driving sprocket without the interference between the powers so that the electric bicycle runs only by the motor power or only by the pressing power onto the pedal or the resultant power of them. Also, a rider can rest putting his or her feet on the pedals or pressing the pedals in the reverse direction when the electric bicycle runs by the motor power. In this case, the power is transmitted to the driving sprocket so that the transmission efficiency is high and the electricity is less consumed.

Also, when the electric bicycle runs only by the pressing power onto the pedal, the pressing of the pedals is easy as the general bicycle.

Further, as the motor is positioned in the lower side, the electric bicycle keeps stable, and a plurality of batteries is installed detachably and the electricity of the batteries can be used sequentially or in parallel.

Especially, according to the second aspect of the present invention, a driving motor connection one-way clutch which receives power from the driving motor is arranged at the opposite side of the driving sprocket side with center of the crank shaft housing so that the installation of the power transmission mechanism becomes easy and convenient. Also, a transmission for shifting gear ratio can be easily installed.

### BRIEF DESCRIPTION OF THE DRAWINGS

FIG. 1 is a view showing an electric bicycle on which a power transmission mechanism according to the first aspect of the present invention is mounted;

FIGS. 2 to 4 are views showing the power transmission mechanism according to the first aspect of the present invention;

FIG. 5 is a view showing a motor arrangement in the power transmission mechanism according to the first aspect of the present invention;

FIGS. 6 and 7 are views showing connection to rear wheel of the power transmission mechanism according to the first aspect of the present invention;

FIG. 8 is a view showing an electric bicycle on which a power transmission mechanism according to the embodiment of the present invention is mounted;

FIGS. 9 to 11 are views showing the power transmission mechanism according to the second aspect of the present invention;

FIGS. 12 and 13 are views showing battery arrangement in the power transmission mechanism according to the second aspect of the present invention;

FIGS. 14 and 15 are views showing a motor arrangement in the power transmission mechanism according to the second aspect of the present invention.

Now, the preferred embodiments of the present invention will be described with reference to the accompanying drawings.

### DETAILED DESCRIPTION

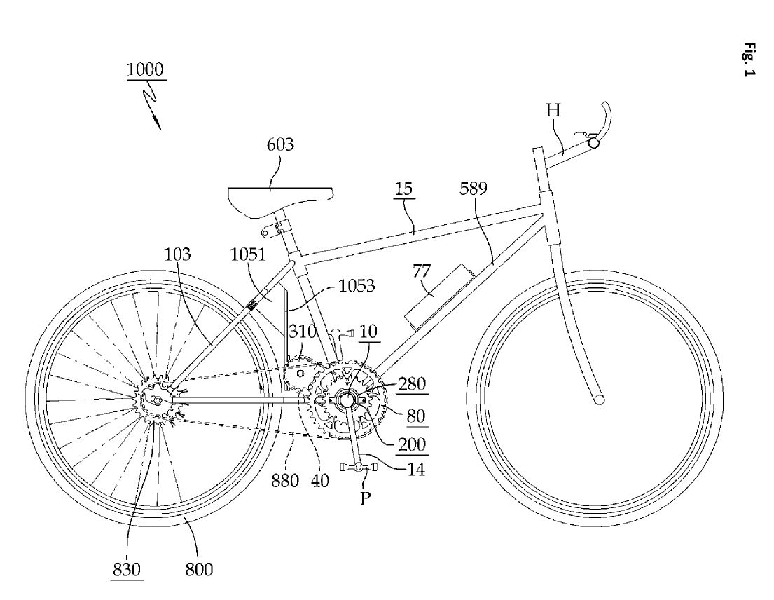

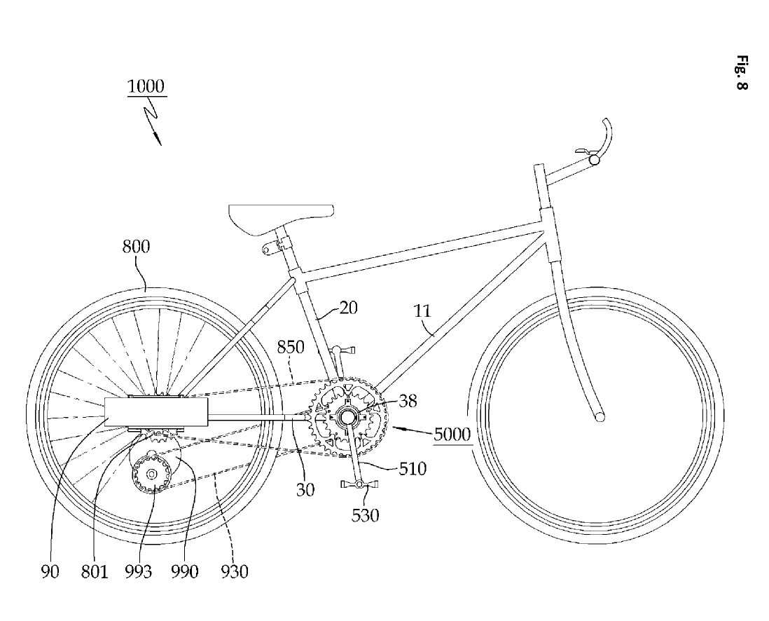

FIGS. 1 to 7 show a power transmission mechanism according to the first aspect of the present invention. FIGS. 8 to 15 show a power transmission mechanism according to the second aspect of the present invention. The power transmission mechanism according to the first aspect or the second aspect of the invention is indicated by the same numeral 5000.

Firstly, FIG. 1 shows an electric bicycle 1000 on which the power transmission mechanism 5000 according to the first aspect of the present invention is mounted. As described later, if the power transmission mechanism 5000 is mounted on a bicycle, the bicycle will be an electric bicycle and the power transmission mechanism 5000 is very easy to be mounted on the bicycle because its constitution is simple.

There shows a crank shaft 10 centering a driving sprocket 80 and a crank arm 14 is connected with the crank shaft 10 and a pedal P is equipped with the crank arm 14. The driving sprocket 80 is connected with a hub sprocket 830 on a hub of a rear wheel 800 through a chain 880.

The power transmission mechanism 5000 according to the first aspect of the present invention is installed around the driving sprocket 80 and it is shown in FIG. 1 that a pedal connection one-way clutch 200 is mounted on the right side of the driving sprocket 80 by means of a pedal side combiner 280.

A motor M is mounted on brackets 1051 and 1053 extending downward at a frame part 103. The frame part 103 extends from the rear wheel 800 to a saddle 603 in a frame 15 of the bicycle. The motor M is connected with a sprocket 310 and the sprocket 310 is connected with a sprocket 108 along outer circumference of an outer wheel 140 of a driving motor connection one-way clutch 100 through a chain 40.

A battery 77 is detachably mounted on a frame part 589 extending from the crank shaft 10 to a handle H in the frame 15.

The motor M operates by the electricity of the battery 77 and a control switch to control the operation of the motor M (not shown) may be provided on the handle H.

According to the present invention, brackets may be arranged at the both side of the hub of the rear wheel and additional batteries are mounted on the brackets. In this case, the batteries are connected in parallel to extend the usage time. In other case, the batteries may be used sequentially as one is exhausted then another is used.

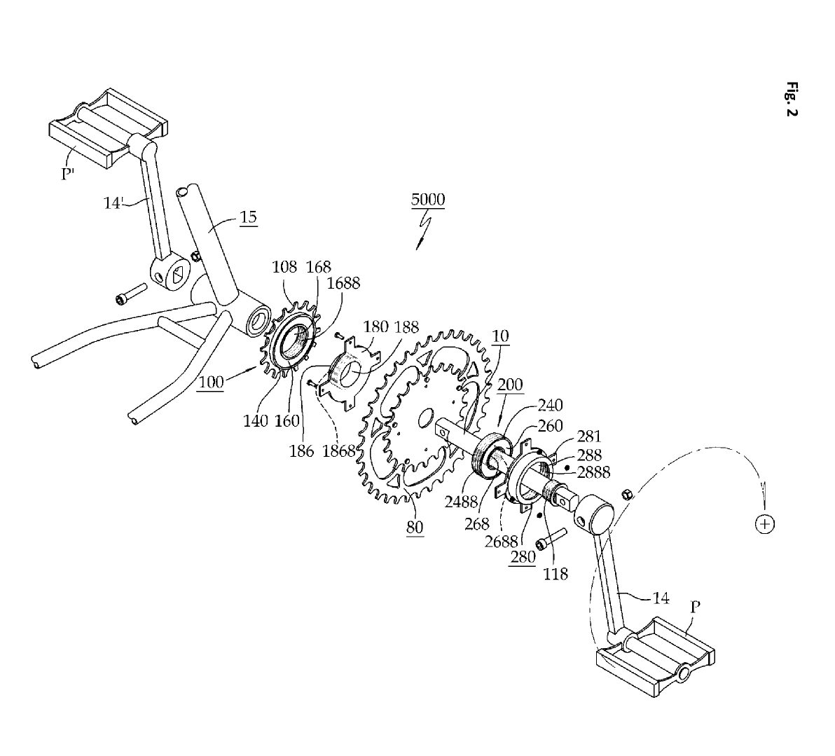

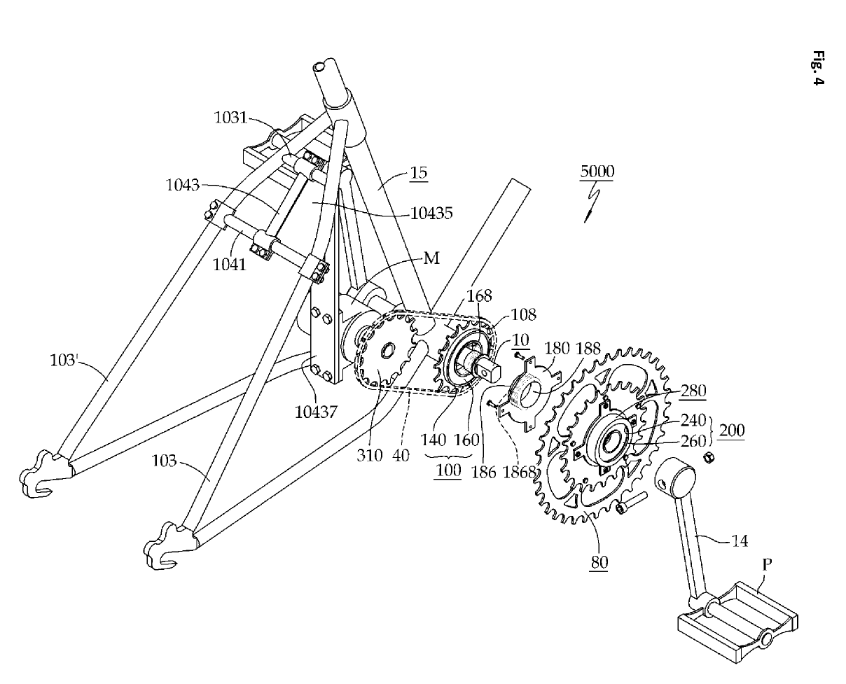

FIGS. 2 and 4 show one embodiment of the power transmission mechanism 5000 according to the first aspect of the present invention.

The driving motor connection one-way clutch 100 is provided. The driving motor connection one-way clutch 100 has the outer wheel 140 and an inner wheel 160. The outer wheel 140 is connected with the driving motor M and receives power from the motor M. The inner wheel 160 is connected with the driving sprocket 80 to transmit its revolution thereto. The outer wheel 140 and the inner wheel 160 are locked each other if the outer wheel 140 runs along positive (+) direction. The lock is released if the inner wheel 160 runs along positive (+) direction.

In this embodiment, the driving motor connection one-way clutch 100 is arranged at the left side of the driving sprocket 80.

The pedal connection one-way clutch 200 is provided and the pedal connection one-way clutch 200 has an outer wheel 240 and an inner wheel 260. The crank shaft 10 is coupled with the inner wheel 260 and the revolution of the crank shaft 10 leads the revolution of the inner wheel 260. The outer wheel 240 is connected with the driving sprocket 80 to transmit its revolution thereto. The outer wheel 240 and the inner wheel 260 are locked each other if the inner wheel 260 runs along positive (+) direction and the lock is released if the outer wheel 240 runs along positive (+) direction.

In this embodiment, the pedal connection one-way clutch 200 is arranged at the right side of the driving sprocket 80.

The crank shaft 10 is arranged to be in noncontact with the one-way clutch 100. That means that the crank shaft 10 and the one-way clutch 100 is physically separated not to directly contact with each other so that the revolution power of the driving motor connection one-way clutch 100 according to the power from the motor M is not transmitted to the crank shaft 10 and, reversely, the revolution power of the crank shaft 10 according to the pressing the pedals P and P′ is not transmitted to the driving motor connection one-way clutch 100. If there is a bearing between the crank shaft and the driving motor connection one-way clutch 100 and they idly revolve each other, they are in noncontact with each other.

In this embodiment, the driving motor connection one-way clutch 100 is connected with the driving sprocket 80 as a motor side combiner 180 coupled with the inner wheel 160 of the driving motor connection one-way clutch 100 is coupled with the driving sprocket 80 at its left side. The pedal connection one-way clutch 200 is connected with the driving sprocket 80 as the pedal side combiner 280 coupled with the outer wheel 240 of the pedal connection one-way clutch 200 is coupled with the driving sprocket 80 at its right side.

In the driving motor connection one-way clutch 100, the sprocket 108 connected with the driving motor M through the chain 40 is formed along the outer wheel 140 and a through-hole 168 along the inner surface of which a thread part 1688 is formed is provided in the inner wheel 160.

The motor side combiner 180 has a protrusion 186 on the outer surface of which there is a thread part 1868 corresponding to the thread part 1688. The protrusion 186 has a through-hole 188.

The thread part 1688 on the through-hole 168 of the driving motor connection one-way clutch 100 is coupled with the corresponding thread part 1868 on the protrusion 186 of the motor side combiner 180 and the driving motor connection one-way clutch 100 is connected with the driving sprocket 80.

In the pedal connection one-way clutch 200, there is a thread part 2488 along the outer circumferential surface of the outer wheel 240. The pedal side combiner 280 has a through-hole 288 along the inner surface of which there is a thread part 2888 corresponding to the thread part 2488 of the outer wheel 240 of the pedal connection one-way clutch 200.

The thread part 2488 on the outer wheel 240 of the pedal connection one-way clutch 200 is coupled with the corresponding thread part 2888 on the thread-hole 288 of the pedal side combiner 280 and the pedal connection one-way clutch 200 is connected with the driving sprocket 80.

The combiners 180 and 280 have extensions for combination 181 and 281 along their radial direction and the extensions for combination 181 and 281 are combined with the driving sprocket 80 by bolts at its left and right sides, respectively.

As shown, the crank shaft 10 is inserted into a through-hole 268 on the inner wheel 260 of the pedal connection one-way clutch 200 and coupled therewith. There is a thread part 2688 on the inner surface of the through-hole 268 which is coupled with a thread part 118 on the crank shaft 10.

The crank shaft 10 passes through the driving sprocket 80 and also passes through the through-hole 188 of the motor side combiner 180 so that the crank shaft 10 is connected with a crank arm 14′ at the opposite.

The diameter of the through-hole 188 of the motor side combiner 180 is larger than the diameter of the crank shaft 10 so that the crank shaft 10 goes through the empty space of the through-hole 188 of the motor side combiner 180. Alternatively, a bearing is provided between the crank shaft 10 and the through-hole 188 and the crank shaft 10 idles with the driving motor connection one-way clutch 100. Accordingly, the crank shaft is in noncontact with the driving motor connection one-way clutch 100.

In this embodiment, the thread part 1688 on the through-hole 168 of the inner wheel 160 of the driving motor connection one-way clutch 100 and the corresponding thread part 1868 on the protrusion 186 of the motor side combiner 180 are left-handed. Accordingly, their couple of the thread parts 1688 and 1868 does not be uncoupled when the power is transmitted from the motor M through chain 40.

The thread part 2488 on the outer wheel 240 of the pedal connection one-way clutch 200 and the corresponding thread part 2888 on the through-hole 288 of the pedal side combiner 280 are right-handed. Accordingly, their couple of the thread parts 2488 and 2888 does not be uncoupled when the crank shaft 10 revolves according to the pressing of the pedal P.

According to the power transmission mechanism 5000, power is transmitted as follows. Accordingly, the electric bicycle 1000 can run only by the motor power or only by the pressing power onto the pedal, or the resultant power of them. Also the rider can press the pedals in the reverse direction or put the feet on the pedals to rest.

The bicycle may be run only by the motor power. The power of the motor M is transmitted to the outer wheel 140 of the driving motor connection clutch 100 through the chain 40. The outer wheel 140 and the inner wheel 160 are locked together and the inner wheel 160 revolves as the outer wheel 140 revolves, then the motor side combiner 180 revolves to revolve the driving sprocket 80 in the positive (+) direction. At this time, the driving motor connection one-way clutch 100 is in noncontact with the crank shaft 10 and the power is not transmitted to the crank shaft 10.

The revolution power of the driving sprocket 80 drives the rear wheel 800. In this case, the pedal side combiner 280 revolves according to the revolution of the driving sprocket 80 in the positive (+) direction and drives the outer wheel 240 of the pedal connection one-way clutch 200. However, the outer wheel 240 idles as the lock is released.

Accordingly, interference with the crank shaft 10 does not happen. The power transmission from the motor M drives the driving sprocket 80 and the rear wheel 800 without the interference with the crank shaft 10 connected with the pedals P and P′. The rider can put the feet on the pedals and rest.

If the rider presses the pedals P and P′ in the reverse direction, the inner wheel 260 coupled with the crank shaft 10 idles as the lock is released and the interference does not happen. Accordingly, the rider can rest putting the feet on the pedals or pressing the pedals in the reverse direction.

The bicycle may be run only by pressing on the pedals. When the rider presses the pedals P and P′ in the positive (+) direction, the crank shaft 10 revolves and the inner wheel 260 of the pedal connection one-way clutch 200 revolves in the positive (+) direction. At this time, the inner wheel 260 and the outer wheel 240 are locked together and the outer wheel 240 revolves as the inner wheel 260 revolves and drives the pedal side combiner 280. Accordingly, the driving sprocket 80 revolves in the positive (+) direction and drives the rear wheel 800.

At this time, the driving motor connection one-way clutch 100 is in noncontact with the crank shaft 10 and the power of the crank shaft 10 is not transmitted to the driving motor connection clutch 100. The motor side combiner 180 revolves according to the revolution of the driving sprocket 80 in the positive (+) direction and drives the inner wheel 160 of the driving motor connection one-way clutch 100. However, the inner wheel 160 idles as the lock between the inner wheel 160 and the outer wheel 140 is released. Accordingly, the revolution of the pedals P and P′ in the positive (+) direction causes that the inner wheel 160 of the driving motor connection one-way clutch 100 idles and does not raise the interference with the motor M.

The bicycle may be run by the resultant power of the motor and pressing the pedals. As mentioned, the power from the motor M drives the driving sprocket 80 and does not raise the interference with the crank shaft 10. Also, the power from the pedal pressing in the positive (+) direction drives the driving sprocket 90 and does not raise the interference with the motor M. Accordingly, the pressing power onto the pedals P and P′ and the motor power drives the driving sprocket 80 in the positive (+) direction, respectively, without interference each other and their resultant power drives the driving sprocket 80 in the positive (+) direction to run the rear wheel 800.

As described, according to the present invention, the rider can drive the electric bicycle by the motor power and, in this case, the rider can rest putting his or her feet on the pedals or pressing the pedals in the reverse direction. Also, the rider can drive the electric bicycle by pressing the pedals with minimum effort. Further, the ride can drive the electric bicycle by the resultant power of the motor and the pressing of the pedal.

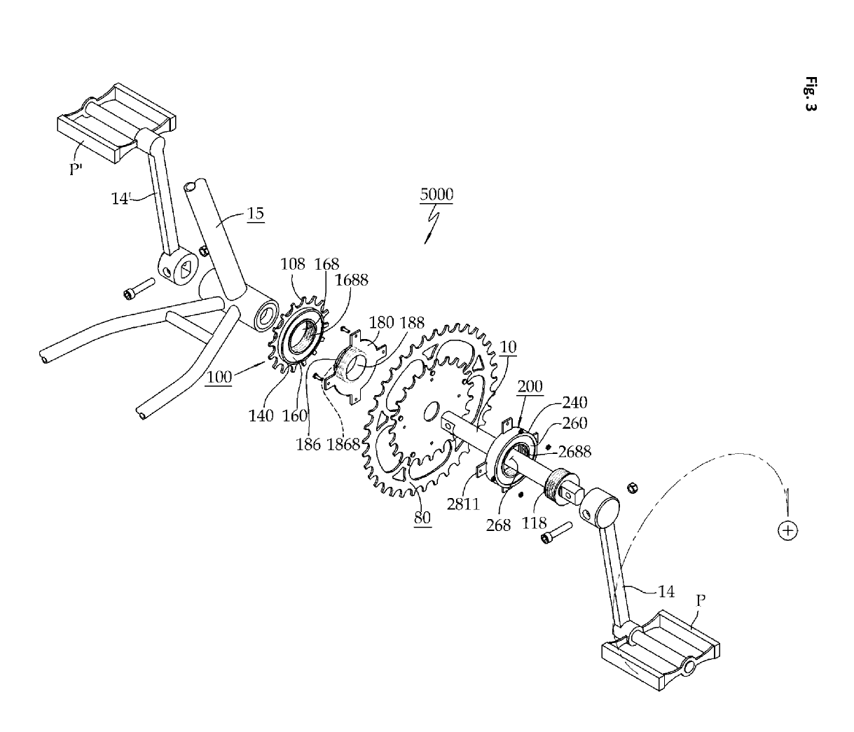

FIG. 3 shows another embodiment of the power transmission mechanism 5000 according to the first aspect of the present invention.

In this case, the outer wheel 240 of the pedal connection one-way clutch 200 has extensions for combination 2811 along their radial direction and the pedal connection one-way clutch 200 is directly connected with the driving sprocket 80 thereby. Also, there is a mass part on the crank shaft 10 along which a thread part 118 is formed corresponding to the thread part 2688 on the through-hole 268 of the inner wheel of the pedal connection one-way clutch 200. The inner wheel 260 of the pedal connection one-way clutch 200 is coupled with the crank shaft 10 by the combination of the thread parts 2688 and 118. By placing the mass part, it is possible to use the pedal connection clutch 200 having the same size as the driving motor connection one-way clutch 100.

The operation of the electrical bicycle according to the embodiment shown in FIG. 3 is the same as the description above.

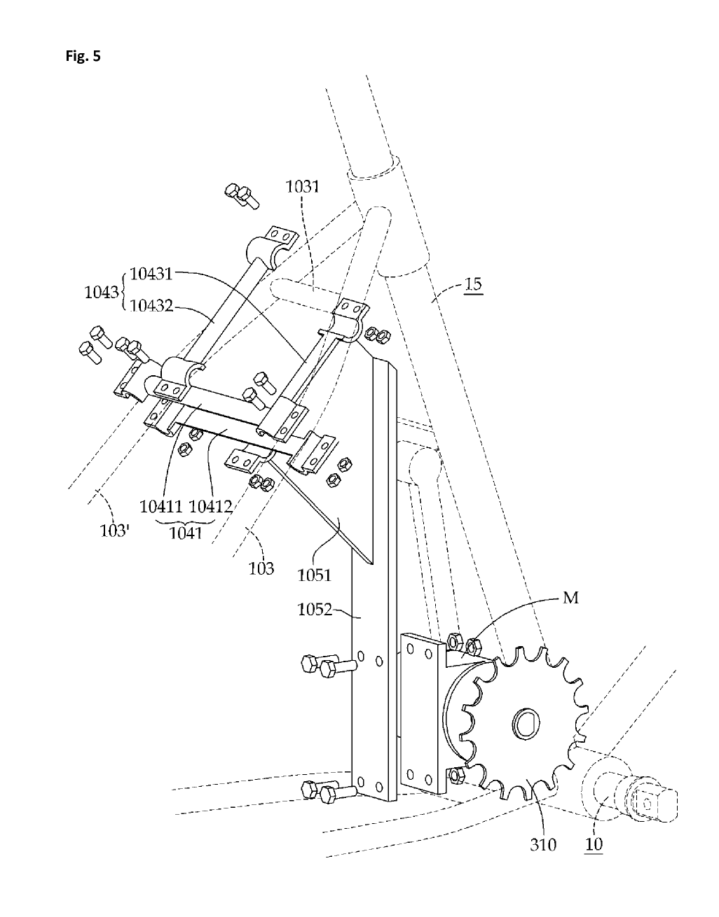

FIG. 5 shows mount structure of the motor M in the power transmission mechanism 5000 of the bicycle according to the present invention.

A traverse bracket 1041 parallel to a traverse bar 1031 traversing the frame parts 103 and 103′ supporting the rear wheel 800 and extending to the saddle 603 is equipped. In this embodiment, the traverse bracket 1041 includes upper and lower brackets 10411 and 10412 coupled by nuts as shown.

A longitudinal bracket 1032 connecting the traverse bar 1031 and the traverse bracket 1043 is equipped. The longitudinal bracket 1043 includes upper and lower brackets 10431 and 10432 coupled by nuts. In the lower bracket 10432, a lower extension bracket 1052 is formed through a wing part 1051.

The motor M is mounted on the lower extension bracket 1052 by bolts. Preferably, the motor M has a reduction gear therein to increase power.

As described, the motor M is mounted on the lower extension bracket 1052 extending from the brackets 1041 and 1042 on the frame parts 103 and 103′ so that the motor M is positioned in the lower side and, preferably, on the next to the driving motor connection one-way clutch 100. Accordingly, the gravity center of the motor is in the lower side and the bicycle keeps stable.

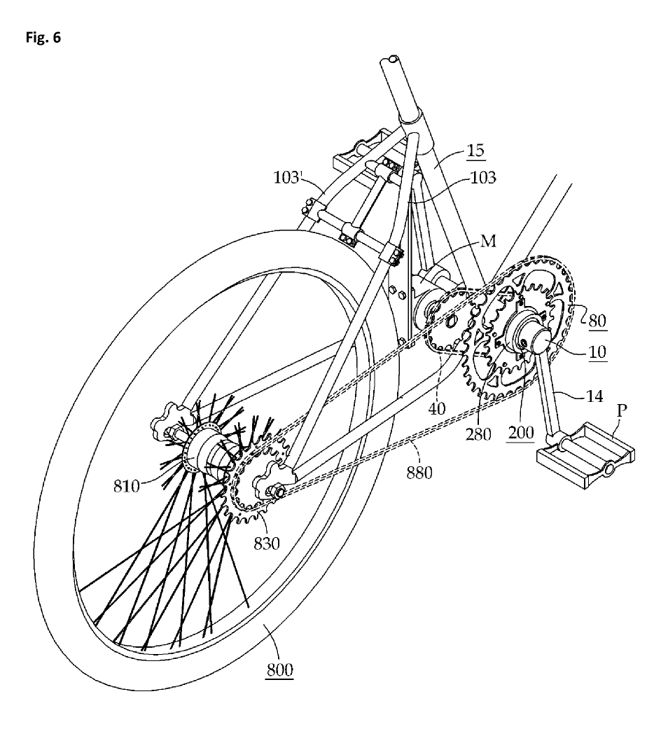

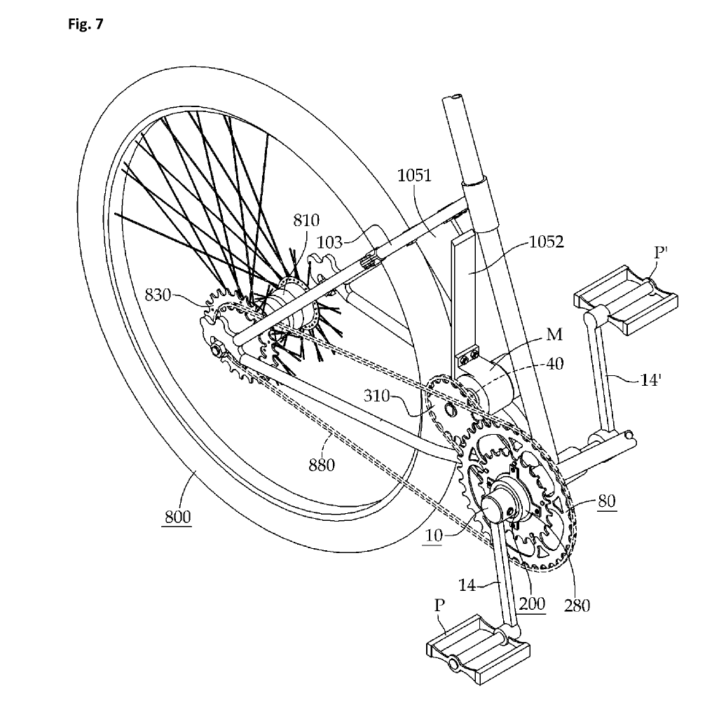

FIGS. 6 and 7 show the connection structure of the power transmission mechanism 5000 for an electrical bicycle to the rear wheel according to the first aspect of the present invention in detail.

As described above, the present invention uses only two one-way clutches to transmit the power from the motor and the pressing of the pedal to the driving sprocket without interference therebetween. Accordingly, the rider can drive the electric bicycle by the motor power or by pressing the pedal, or by the resultant power of the motor and the pressing of the pedal. The rider can rest putting his or her feet on the pedals or pressing the pedals in the reverse direction when the bicycle runs by the motor power.

The present invention transmits the power to the driving sprocket, which has high power transmission efficiency. Accordingly, the electricity is less consumed and it is not hard to press the pedal.

Also, the motor is positioned in the lower side and the bicycle keeps stable. A plurality of batteries is conveniently installed detachably and the electricity of the batteries can be used sequentially or in parallel.

FIGS. 8 to 15 show the power transmission mechanism according to the second aspect of the present invention.

FIG. 8 shows an electric bicycle 1000 on which the power transmission mechanism 5000 according to the second aspect of the present invention is mounted. If the power transmission mechanism 5000 is mounted on a bicycle, the bicycle will be an electric bicycle and the power transmission mechanism 5000 has simple constitution and is very easy to be mounted on the bicycle.

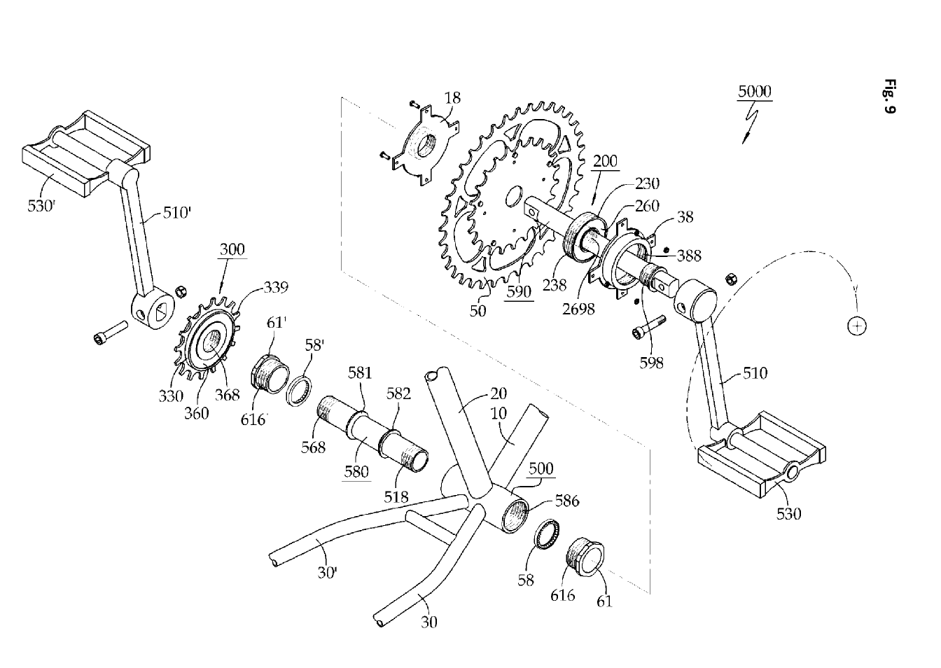

There shows frames 10, 20 and 30 with center of a crank housing shaft 500 of the bicycle. A crank shaft 590 is installed with respect to the crank shaft housing 500 and a driving sprocket 50 is mounted on the crank shaft 590 and a pedal 530 is equipped with a crank arm 510 connected to the crank shaft 590. (Refer to FIG. 9)

The driving sprocket 50 is connected with a hub sprocket 801 mounted on a hub of a rear wheel 800 through a chain 850. Accordingly, the revolution of the driving sprocket 50 leads the revolution of the rear wheel 800 and the bicycle runs.

It is shown that a pedal side combiner 38 is mounted on the driving sprocket 50. The pedal side combiner 38 is mounted on an outer wheel 230 of a pedal connection one-way clutch 200 on the crank shaft 590 and mounted on the external side of the driving sprocket 50. It will be described later.

A battery 90 is mounted on the side where the driving sprocket is arranged and a driving motor 990 is arranged at the opposite side. A chain 930 is mounted on a sprocket 993 of the driving motor 990. As described later, the chain 930 connects the driving motor 990 with an outer wheel 330 of a driving motor connection clutch 300.

FIGS. 9 to 11 show the power transmission mechanism 5000 for an electrical bicycle according to the second aspect of the present invention.

Firstly, an outer shaft 580 which is hollow is provided. The crank shaft 590 passes through the hollow outer shaft 580.

The outer shaft 580 is arranged to be through the crank shaft housing 580 and bearings 58 and 58′ are mounted between the crank shaft housing 500 and the outer shaft 580 for the smooth revolution of the outer shaft therein.

Sleeve (not shown) is provided between the outer shaft and the crank shaft 590 for the smooth revolution of the crank shaft 590 therein.

The outer shaft 580 has protrusions 581 and 582 along the outer perimeter to arrange the bearings 58 and 58′ and tightening members 61 and 61′ are mounted on each side to keep the arranged bearings 58 and 58′;

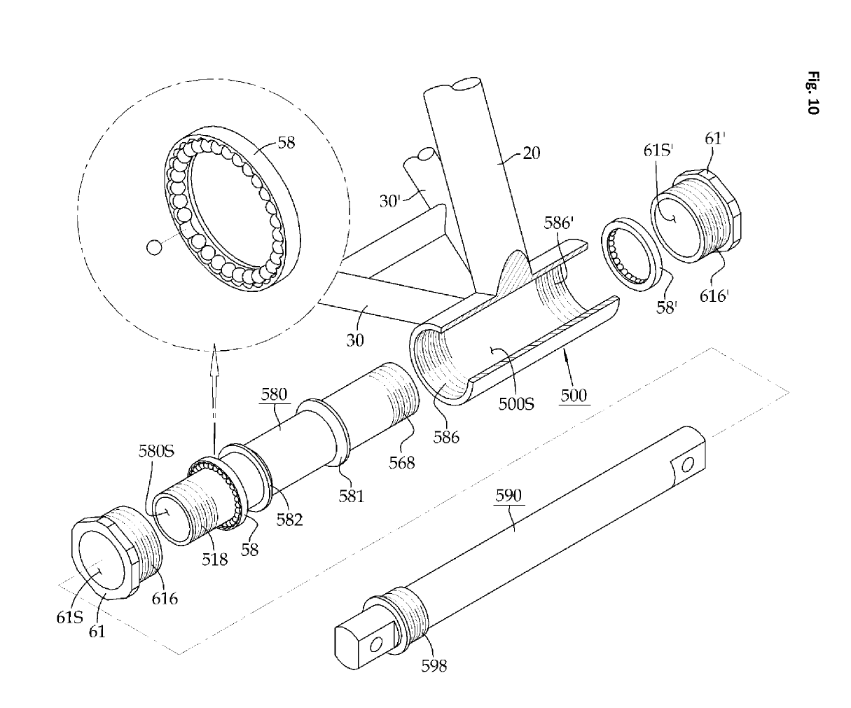

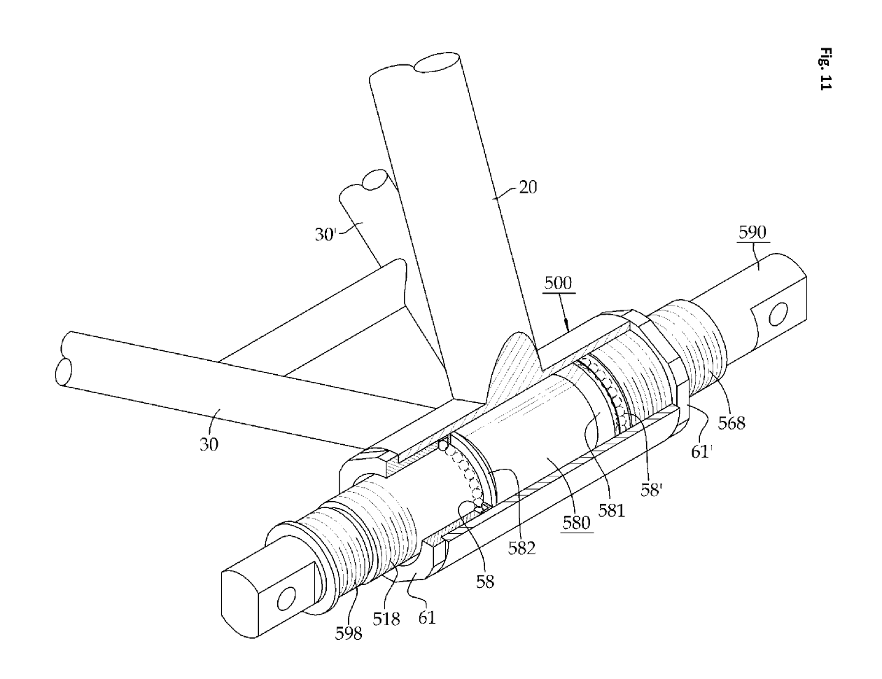

With reference to FIGS. 10 and 11, thread part 586 and 586′ are provided on the inner surface of a through-hole 500s at each side of the crank shaft 500. The outer shaft 580 on the protrusions 581 and 582 of which the bearings 58 and 58′ are arranged is placed on the through-hole 500s of the crank shaft housing 500 and the tighten members 61 and 61′ are tightened at both sides of the through-hole 500s of the crank housing 500 so that thread parts 161 and 616′ couple with the thread parts 586 and 586′ on the inner surface of the crank housing 500 at each side and the bearings 58 and 58′ keeps the arranged position stably.

As shown, the crank shaft 590 passes through-holes 61s and 61s′ of the tightening members 61 and 61′ and a through-hole 580s of the outer shaft 580.

According to the second aspect of the present invention, a driving motor connection one-way clutch 300 is provided. The driving motor connection one-way clutch 300 has an internal wheel 360 mounted on the outer shaft 580 and an outer wheel 330 connected with the driving motor 990 to receive power therefrom.

The outer wheel 330 and the inner wheel 360 of the one-way clutch 300 are locked each other if the outer wheel 330 runs along positive direction ((+) direction in the drawing and the revolution direction to run the bicycle) and revolve together. The lock is released and the inner wheel 360 idles if the inner wheel 360 runs along positive (+) direction.

In this embodiment, a motor connection sprocket 339 is formed on the outer wheel 330 of the driving motor connection one-way clutch 300 and connected with the sprocket 993 of the driving motor 990 by the chain 930.

In the through-hole of the inner wheel 360 of the driving motor connection one-way clutch 300, a thread part 368 is formed on the inner surface thereof. Corresponding thread part 568 is formed on the outer circumference at the end of the outer shaft 580. The thread parts 368 and 568 are combined together and the driving motor connection one-way clutch 300 is mounted on the outer shaft 580.

The driving motor 990 and the driving motor connection one-way clutch 300 are arranged at the same side and they are arranged at the opposite side of the driving sprocket 500 with center of the crank shaft housing 500 of the bicycle.

The outer shaft 580 is connected with the driving sprocket 50.

In this embodiment, an outer shaft combiner 18 mounted on the outer shaft 580 is coupled with the driving sprocket 50 so that the outer shaft 580 is connected with the driving sprocket 50. A thread part 518 is formed along the outer circumference of the outer shaft at the opposite side to the side on which the driving motor connection one-way clutch 300 is mounted and a thread part on the inner surface of the through-hole of the outer shaft combiner 18 is combined therewith. The outer shaft combiner 18 is coupled on a side of the driving sprocket 50. Accordingly, the outer shaft 580 is connected with the driving sprocket 50.

With reference to FIGS. 10 and 11, the outer shaft 580 passes through the crank shaft housing 500 and protrudes at the both ends thereof. The thread parts 568 and 518 are formed on both of the protruded portion of the outer shaft 580, respectively, on which the driving motor connection one-way clutch 300 and the outer shaft combiner 18 is mounted, respectively.

According to the second aspect of the present invention, a pedal connection one-way clutch 200 is provided. The pedal connection one-way clutch 200 has an outer wheel 230 with which the driving sprocket 50 is connected and an inner wheel 260 mounted on the crank shaft 590.

The outer wheel 230 and the inner wheel 260 of the pedal connection one-way clutch 200 are locked each other if the inner wheel 230 runs along positive direction ((+) direction in the drawing and the revolution direction to run the bicycle) and revolve together. The lock is released and the outer wheel 230 idles if the outer wheel 230 runs along positive (+) direction.

In this embodiment, a thread part 598 is formed on the end of the crank shaft 590 towards the pedal 530 and, correspondingly, a corresponding thread 2698 is formed on the inner surface of a through-hole of the inner wheel 260 of the pedal connection one-way clutch 200 so that the thread parts 598 and 2698 are combined with each other and the pedal connection one-way clutch 200 is mounted on the crank shaft 590.

Also, a thread part 238 along the outer circumference of the outer wheel 230 of the pedal connection one-way clutch 200 is combined with a corresponding thread 388 on the inner surface of a through-hole of a pedal combiner 38 and the pedal combiner 38 is coupled with the driving sprocket 50 at its external side. Accordingly the outer wheel 230 of the pedal connection one-way clutch 200 is connected with the driving sprocket 50.

With reference to FIGS. 10 and 11, the thread part 598 is formed on the protruded portion of the crank shaft 590 protruded externally after passing through the outer shaft 580 which is through the crank shaft housing 500 and the corresponding thread part 2698 of the pedal connection one-way clutch 200 is combined therewith so that the inner wheel 260 of the pedal connection one-way clutch 200 is mounted on the crank shaft 590.

FIGS. 10 and 11 show an example structure of the outer shaft 580 and the crank shaft 590 equipped with the crank housing 500.

As described above, the outer shaft 580 is arranged to pass through the through-hole 500s Of the crank housing 500 and the crank shaft 590 is arranged to pass through the through-hole 580s Of the outer shaft 580. The bearings 58 and 58′ are placed between the crank housing 500 and the outer shaft 580 and the tightening members 61 and 61′ are mounted for the bearings 58 and 58′.

As described above, the outer shaft 580 passes through the crank shaft housing 500 and protrudes at the both ends thereof. The thread parts 568 and 518 are formed on both of the protruded portion of the outer shaft 580 and the driving motor connection one-way clutch 300 and the outer shaft combiner 18 are mounted thereon, respectively. Also, at the protruded portion of the crank shaft 590 from the outer shaft 580, the crank shaft 590 passing through the outer shaft 580 which is through the crank housing 500, the thread part 598 is formed with which the corresponding thread part 2698 of the pedal connection one-way clutch 200 is combined so that the inner wheel 260 is mounted on the crank shaft 590.

The crank shaft 590 passes through and protrudes from the outer shaft 580 on which the driving motor connection one-way clutch 300 is mounted and the crank shaft 590 and the driving motor connection one-way clutch 300 is in noncontact with each other. That means that the crank shaft 590 and the driving motor connection one-way clutch 300 is physically separated not to directly contact with each other so that the revolution power of the driving motor connection one-way clutch 300 according to the power from the motor 990 is not transmitted to the crank shaft 590 and, reversely, the revolution power of the crank shaft 590 according to the pressing the pedals 530 and 530′ is not transmitted to the driving motor connection one-way clutch 300. If there is provided a bearing between the crank shaft 590 and the driving motor connection one-way clutch 300 and they idly revolve each other, they are in noncontact with each other.

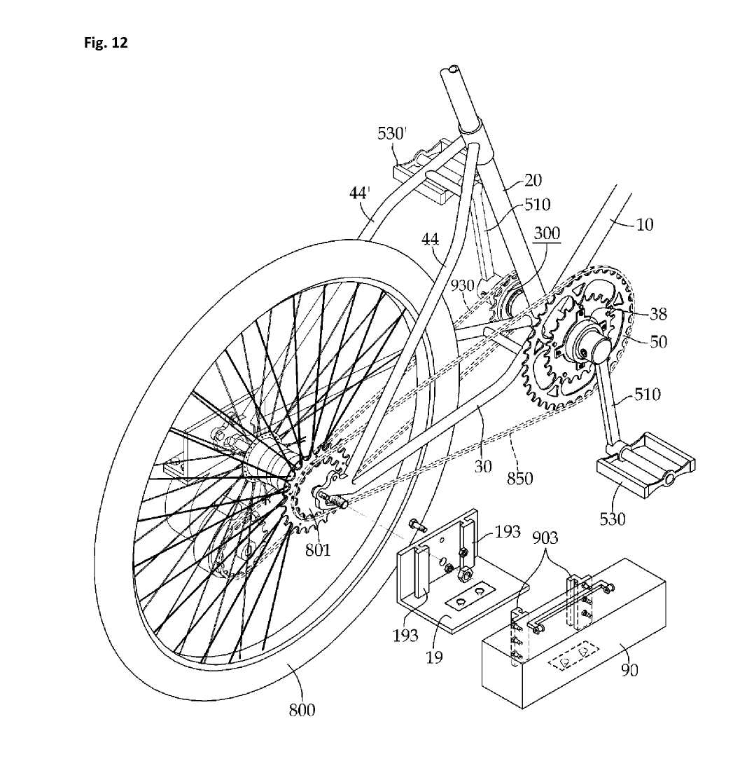

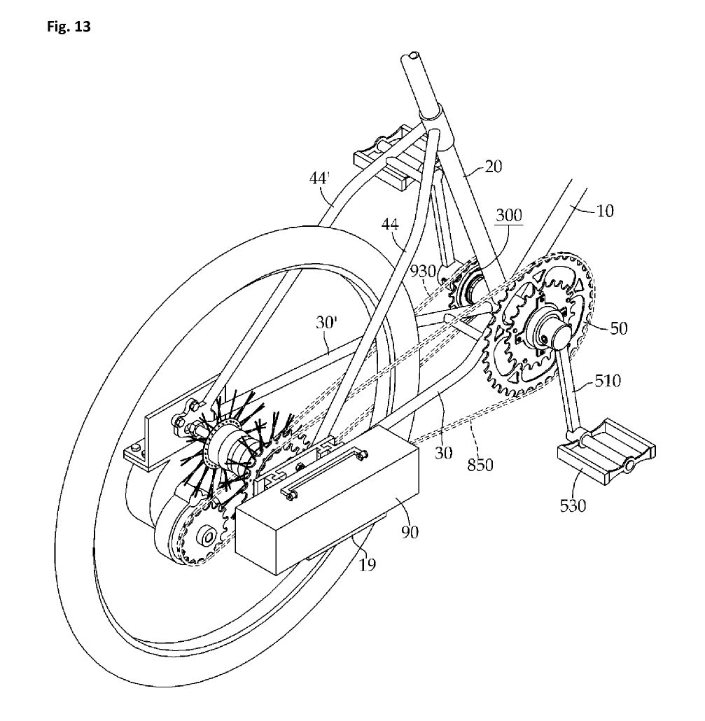

FIGS. 12 and 13 show the arrangement structure of the battery 90 on the electrical bicycle 1000 according to an embodiment of the present invention. As shown, the battery 90 has protrusions 903 on a side thereof and bracket 19 for mounting the battery 90 on which grooves 193 corresponding to the protrusions 903 are provided. The bracket 19 for mounting the battery 90 is arranged on a side of a frame 40 supporting the rear wheel 800.

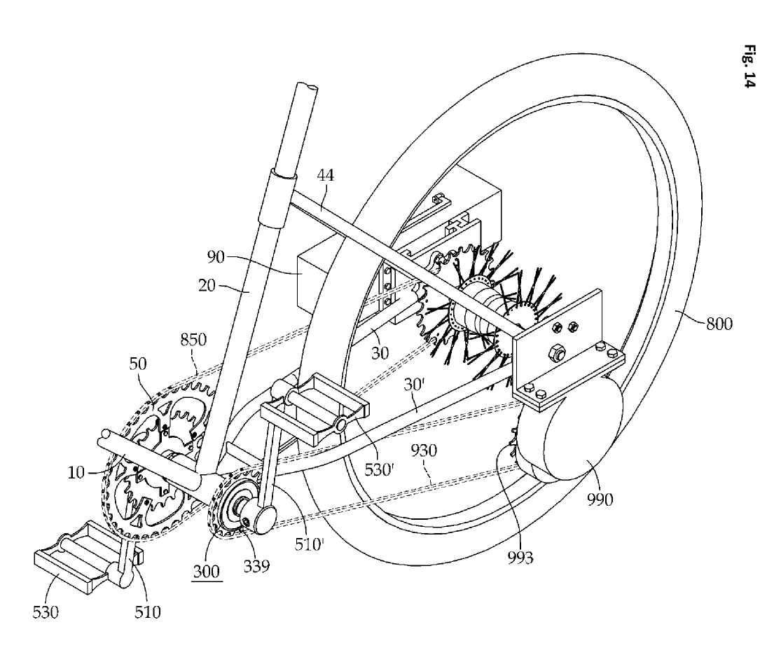

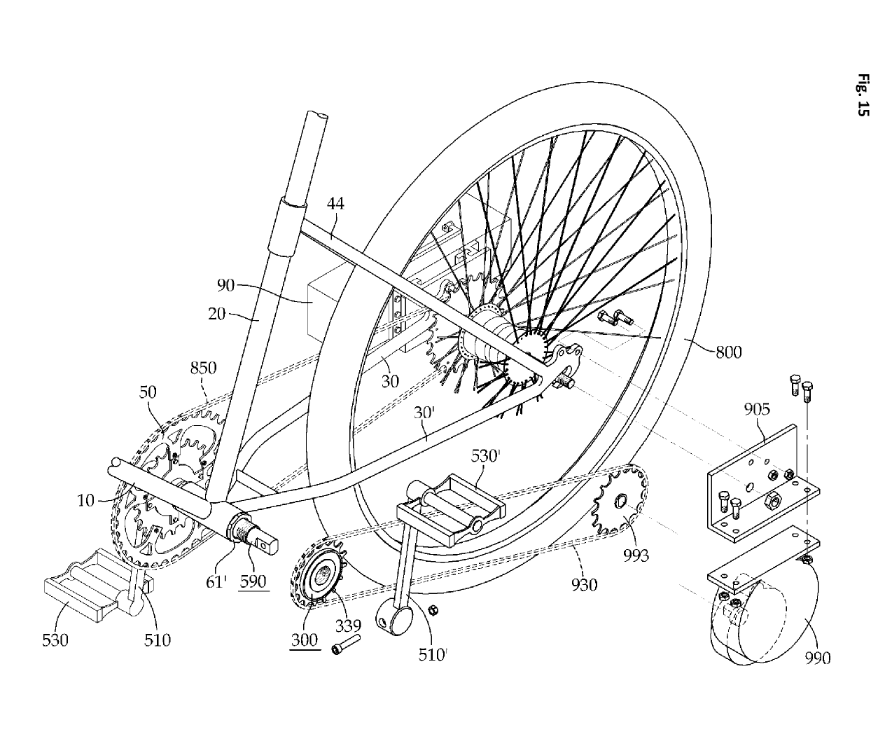

FIGS. 14 and 15 show the arrangement structure of the driving motor 990 on the electrical bicycle 1000 according to the second aspect of the present invention. A shown, a bracket 905 for mounting the driving motor 990 is arranged on a side of the frame 40′ supporting the rear wheel 800 and the driving motor 990 is mounted on the bracket 905.

The sprocket 993 is mounted on the driving motor 990 and the chain 990 is arranged between the sprocket 993 of the driving motor 990 and the sprocket 339 of the outer wheel 330 of the driving motor connection clutch 300 so that the power of the driving motor 990 is transmitted to the outer wheel 330 of the driving motor connection clutch 300. In this embodiment, the driving motor 990 is arranged on the side of the rear wheel 800. However, the driving motor 990 may be arranged anywhere in the frame of the bicycle. That is the same as the battery 90.

According to the power transmission mechanism 5000, power is transmitted as follows. The electric bicycle 1000 can run only by the motor power or only by the pressing power onto the pedal, or the resultant power of them. The rider can rest pressing the pedals in the reverse direction or putting the feet on the pedals when the electric bicycle runs by the motor power.

The bicycle may be run only by motor power. The power of the motor 990 is transmitted to the outer wheel 330 of the driving motor connection clutch 300 through the chain 930. The outer wheel 330 and the inner wheel 360 are locked together and the inner wheel 360 revolves as the outer wheel 330 revolves, then the outer shaft 580 on which the inner wheel 360 is mounted revolves so that the driving sprocket 50 connected with the outer shaft combiner 18 which is coupled with the outer shaft 580 revolves in the positive (+) direction. At this time, the driving motor connection one-way clutch 300 is in noncontact with the crank shaft 590 and the pedal combiner 38 revolves by the revolution of the driving sprocket 50 in the positive (+) direction. The outer wheel 230 of the pedal connection one-way clutch 200 revolves, but the inner wheel 260 does not revolve and the outer wheel 230 idles with respect to the inner wheel 260. Accordingly, the power from the motor 990 is not transmitted to the crank shaft 590. The revolution of the driving sprocket 50 drives the rear wheel 800. Accordingly, the power from the motor 990 drives the driving sprocket 50 and the rear wheel 800 without the interference with the crank shaft 590 connected with the pedals 530 and 530′. As a result, the rider can put the feet on the pedals and rest.

If the rider presses the pedals 530 and 530′ in the reverse direction, the inner wheel 260 coupled with the crank shaft 590 idles as the lock is released and the interference does not happen. Accordingly, the rider can rest putting the feet on the pedals or pressing the pedals in the reverse direction.

The bicycle may be run only by pressing on the pedals. When the rider presses the pedals 530 and 530′ in the positive (+) direction, the crank shaft 590 revolves and the inner wheel 260 of the pedal connection one-way clutch 200 revolves in the positive (+) direction. At this time, the inner wheel 260 and the outer wheel 230 are locked together and the outer wheel 230 revolves as the inner wheel 260 revolves and drives the pedal side combiner 38. Accordingly, the driving sprocket 50 revolves in the positive (+) direction and drives the rear wheel 800.

At this time, the driving motor connection one-way clutch 300 is in noncontact with the crank shaft 590. The outer wheel 580 revolves by the revolution of the driving sprocket 50 and the inner wheel 360 of the driving motor connection one-way clutch 300 revolves accordingly. However, the inner wheel 260 idly revolves and does not revolve the outer wheel 330 because the lock between the inner wheel 360 and the outer wheel 330 is released. Accordingly, the revolution of the crank shaft 590 does not transmit the power to the driving motor connection one-way clutch 300 and cause the interference with the motor 990.

The bicycle may be run by the resultant power of the motor and pressing the pedals. As mentioned, the power from the motor 990 drives the driving sprocket 50 in the positive (+) direction and does not raise the interference with the crank shaft 590. Also, the power by pressing the pedals 530 and 530′ in the positive (+) direction drives the driving sprocket 50 in the positive (+) direction and does not raise the interference with the motor 990.

Accordingly, the pressing power onto the pedals 530 and 530′ and the motor power drives the driving sprocket 50 in the positive (+) direction, respectively, without interference each other and their resultant power drives the driving sprocket 50 in the positive (+) direction to run the rear wheel 800.

According to the present invention, only two one-way clutches are used to transmit the motor power and the pressing power onto the pedal to the driving sprocket without the interference so that the electric bicycle runs only by the motor power or only by the pressing power onto the pedal or the resultant power of them. Also, a rider can rest putting his or her feet on the pedals or pressing the pedals in the reverse direction when the electric bicycle runs by the motor power. In this case, the power is transmitted to the driving sprocket so that the transmission efficiency is high and the electricity is less consumed and it is not hard to press the pedals.

Especially, according to the second aspect of the present invention, a driving motor connection one-way clutch which receives power from the driving motor is arranged at the opposite side of the driving sprocket side with center of the crank shaft housing so that the installation of the power transmission mechanism becomes easy and convenient. Also, a transmission for shifting gear ratio can be easily mounted.

1. A power transmission mechanism for an electrical bicycle comprising:
(a) a driving motor mounted on a bicycle;
(b) a driving motor connection one-way clutch an outer wheel of which is connected with the driving motor and an inner wheel of which is connected with a driving sprocket of the bicycle to transmit the revolution power of the inner wheel to the driving sprocket; wherein the outer wheel and the inner wheel are locked together as the outer wheel revolves in the positive direction and the lock is released as the inner wheel revolves in the positive direction;
(c) a pedal connection one-way clutch an inner wheel of which is connected with a crank shaft of the bicycle and an outer wheel of which is connected with the driving sprocket of the bicycle to transmit the revolution power of the outer wheel to the driving sprocket; wherein the outer wheel and the inner wheel are locked together as the inner wheel revolves in the positive direction and the lock is released as the outer wheel revolves in the positive direction.

2. The power transmission mechanism as claimed in claim 1 wherein the crank shaft is in noncontact with the driving motor connection one-way clutch.

3. The power transmission mechanism as claimed in claim 2 wherein the driving motor connection one-way clutch and the pedal connection one-way clutch are arranged at left and right sides of the driving shaft, respectively.

4. The power transmission mechanism as claimed in claim 3 wherein a motor side combiner coupled with the inner wheel of the driving motor connection one-way clutch is coupled with the left side of the driving sprocket so that the driving motor connection one-way clutch is connected with the driving sprocket, and a pedal side combiner coupled with the outer wheel of the pedal connection one-way clutch is coupled with the right side of the driving sprocket so that the pedal connection one-way clutch is connected with the driving sprocket.

5. The power transmission mechanism as claimed in claim 3 wherein a motor side combiner coupled with the inner wheel of the driving motor connection one-way clutch is coupled with the left side of the driving sprocket so that the driving motor connection one-way clutch is connected with the driving sprocket, and extensions for combination formed on the outer wheel of the pedal connection one-way clutch is coupled with the right side of the driving sprocket so that the pedal connection one-way clutch is connected with the driving sprocket.

6. The power transmission mechanism as claimed in claim 4 wherein a sprocket formed on the outer wheel of the driving motor connection one-way clutch is connected with the driving motor through a chain, a through-hole along the inner surface of which a thread part is formed is provided in the inner wheel of the driving motor connection one-way clutch, the motor side combiner has a protrusion on the outer surface of which a thread part is formed corresponding to the thread part on the inner surface of the through-hole in the inner wheel of the driving motor connection one-way clutch, a through-hole is provided in the protrusion, and the thread part on the through-hole of the inner wheel of the driving motor connection one-way clutch is coupled with the corresponding thread part on the protrusion of the motor side combiner so that the driving motor connection one-way clutch is connected with the driving sprocket.

7. The power transmission mechanism as claimed in claim 6 wherein a thread part along the outer circumferential surface of the outer wheel is provided i the pedal connection one-way clutch, the pedal side combiner has a through-hole along the inner surface of which a thread part is formed corresponding to the thread part of the outer wheel of the pedal connection one-way clutch, the thread part on the outer wheel of the pedal connection one-way clutch is coupled with the corresponding thread part on the thread-hole of the pedal side combiner and the pedal connection one-way clutch is connected with the driving sprocket.

8. The power transmission mechanism as claimed in claim 5 wherein a sprocket formed on the outer wheel of the driving motor connection one-way clutch is connected with the driving motor through a chain, a through-hole along the inner surface of which a thread part is formed is provided in the inner wheel of the driving motor connection one-way clutch, the motor side combiner has a protrusion on the outer surface of which a thread part is formed corresponding to the thread part on the inner surface of the through-hole in the inner wheel of the driving motor connection one-way clutch, a through-hole is provided in the protrusion, and the thread part on the through-hole of the inner wheel of the driving motor connection one-way clutch is coupled with the corresponding thread part on the protrusion of the motor side combiner so that the driving motor connection one-way clutch is connected with the driving sprocket.

9. The power transmission mechanism as claimed in claim 8 wherein the outer wheel of the pedal connection one-way clutch has extensions for combination along their radial direction and the pedal connection one-way clutch is connected with the driving sprocket thereby, a mass part is provided on the crank shaft along which a thread part is formed corresponding to the thread part on the through-hole of the inner wheel of the pedal connection one-way clutch, and the threads are combined so that the inner wheel of the pedal connection one-way clutch is coupled with the crank shaft.

10. The power transmission mechanism as claimed in claim 4 wherein the diameter of the through-hole of the motor side combiner is larger than the diameter of the crank shaft so that the crank shaft goes through the empty space of the through-hole of the motor side combiner and the crank shaft is in noncontact with the driving motor connection one-way clutch.

11. A power transmission mechanism for an electrical bicycle comprising:
(a) a driving motor mounted on a bicycle;
(b) an outer shaft which is hollow, through which a crank shaft of the bicycle passes and which is connected with a driving sprocket of the bicycle;
(c) a driving motor connection one-way clutch an inner wheel of which is mounted on the outer shaft and an outer wheel of which is connected with the driving motor to receive power therefrom; wherein the outer wheel and the inner wheel are locked together as the outer wheel revolves in the positive direction and the lock is released as the inner wheel revolves in the positive direction;
(d) a pedal connection one-way clutch an inner wheel of which is mounted on the crank shaft of the bicycle and an outer wheel of which is connected with the driving sprocket of the bicycle;
wherein the outer wheel and the inner wheel are locked together as the inner wheel revolves in the positive direction and the lock is released as the outer wheel revolves in the positive direction.

12. The power transmission mechanism as claimed in claim 11 wherein the outer shaft is arranged to be through a crank shaft housing of the bicycle and the driving motor connection one-way clutch is arranged at the opposite side of the driving sprocket of the bicycle with center of the crank shaft housing.

13. The power transmission mechanism as claimed in claim 11 wherein the crank shaft passes through the outer shaft on which the driving motor connection one-way clutch is mounted and the crank shaft and the driving motor connection one-way clutch are in noncontact with each other.

14. The power transmission mechanism as claimed in claim 13 wherein an outer surface combiner mounted on the outer shaft is coupled with the driving sprocket of the bicycle so that the outer shaft is coupled with the driving sprocket of the bicycle.

15. The power transmission mechanism as claimed in claim 13 wherein a pedal side combiner mounted on the outer wheel of the pedal connection one-way clutch is coupled with the driving sprocket of the bicycle so that the pedal connection one-way clutch is coupled with the driving sprocket of the bicycle.

16. The power transmission mechanism as claimed in claim 5 wherein the pedal connection one-way clutch is coupled with the driving sprocket at its external side.

17. The power transmission mechanism as claimed in claim 14 wherein the driving motor connection one-way clutch and the outer shaft combiner are mounted on protruded portion of the outer shaft from the crank shaft housing at its both ends, respectively.

18. The power transmission mechanism as claimed in claim 17 wherein the pedal connection one-way clutch is mounted on the protruded portion of the crank shaft from the outer shaft.

19. The power transmission mechanism as claimed in claim 18 wherein a bearing is provided between the crank housing and the outer shaft.

20. A method for operating a bicycle comprising the power transmission mechanism of claim 1, the method comprising:
operating the bicycle in a first mode wherein the bicycle is run only by power of the driving motor wherein:
power of the driving motor is transmitted to the outer wheel of the driving motor connection one-way clutch through a chain;
the driving motor connection one-way clutch outer wheel and inner wheel are locked together and the inner wheel revolves as the outer wheel revolves;
a motor side combiner revolves to revolve the driving sprocket;
the driving motor connection one-way clutch is in noncontact with the crank shaft and the power is not transmitted to the crank shaft;
the revolution power of the driving sprocket drives a rear wheel of the bicycle; and
the outer wheel of the pedal connection one-way clutch outer wheel idles;
running the bicycle only by pressing on the pedals wherein:
the rider presses the pedals in the positive direction;
the crank shaft revolves and the inner wheel of the pedal connection one-way clutch revolves in the positive direction;
the pedal connection one-way clutch inner wheel and outer wheel 240 are locked together and the outer wheel revolves as the inner wheel revolves and drives the pedal side combiner;
the driving sprocket revolves in the positive direction and drives the rear wheel;
the driving motor connection one-way clutch is in noncontact with the crank shaft and the power of the crank shaft is not transmitted to the driving motor connection clutch;
the motor side combiner revolves according to the revolution of the driving in the positive direction and drives the inner wheel of the driving motor connection one-way clutch; and
the inner wheel of the driving motor connection one-way clutch idles; and
running the bicycle by the power of the motor and by pressing on the pedals wherein:
the rider presses the pedals in the positive direction;
power applied to the pedals and the motor power drives the driving sprocket in the positive direction and their resultant power drives the driving sprocket in the positive direction to run the rear wheel.
